(19) United States
(12) Patent Application Publication
(10) Pub. No.: US 2015/0129363 A1
(43) Pub. Date: May 14, 2015

(54) PUMP AND HYDRODYNAMIC RETARDER EQUIPPED WITH SAID PUMP AND GEAR UNIT EQUIPPED WITH SUCH A PUMP

(71) Applicant: ZF Friedrichshafen AG, Friedrichshafen (DE)

(72) Inventor: Heinz Wanninger, Meckenbeuren (DE)

(21) Appl. No.: 14/398,148

(22) PCT Filed: May 15, 2013
(86) PCT No.: PCT/EP2013/060006

§ 371 Date: Oct. 31, 2014

(30) Foreign Application Priority Data
May 16, 2012 (DE) 102012208244.1

(51) Int. Cl. F04B 49/18; F16H 57/04; F04C 14/22

(52) U.S. Cl. CPC F04B 49/18; F04C 14/226; F16H 57/0436
USPC 184/32; 417/228

(57) ABSTRACT

A pump has a pressure chamber and a control ring which is mounted to pivot about a pivoting axis and which undergoes a pivoting motion. The control ring can be pivoted about a deflection angle during its pivoting movement. An aperture is provided in the pressure chamber of the pump. The aperture opens or closes to varying degree based on the pivoting motion of the control ring. In a hydrodynamic retarder with such a pump, a lubricating and cooling medium is supplied at least to bearings of rotating components of the retarder. Differentiated lubrication and cooling, at least of the bearings, can be brought about during braking operation and during non-braking operation of the retarder.

This application is a National Stage completion of PCT/EP2013/060006 filed May 15, 2013, which claims priority from German patent application serial no. 10 2012 208 244.1 filed May 16, 2012.

### FIELD OF THE INVENTION

The invention concerns a pump and a hydrodynamic retarder, which is provided on a vehicle transmission. Preferably, the pump supplies at least bearings for rotating components of the retarder with a lubricating and cooling medium, and means are provided which bring about differentiated lubrication and cooling at least of the bearings when the retarder is operating with braking effect and without braking effect.

### BACKGROUND OF THE INVENTION

Besides the service brakes of a vehicle, which are usually in the form of friction brakes subject to wear, particularly in commercial vehicles additional, wear-free slowing-down devices such as retarders are used. Retarders include both additional hydrodynamic, hydrostatic or electrodynamic braking devices arranged on the transmission or on the engine, and systems which, in the form of a so-termed intarder, are arranged within the transmission housing. Furthermore a distinction is made between primary retarders, which work as a function of the engine speed, and secondary retarders which work as a function of the speed of the vehicle. In hydrodynamic retarders, to brake the vehicle the rotor is generally connected directly to a transmission shaft. In the case of primary retarders this shaft is the driveshaft or transmission input shaft, while in the case of secondary retarders it is the transmission output shaft. The stator of the retarder is as a rule arranged fixed to the housing, and the retarder is then usually not activated when a working space between the rotor and the stator is not filled with a fluid.

To keep the dimensions of a hydrodynamic retarder small, the possibility exists of increasing the transmission ratio from the transmission shaft to the rotor of the retarder to ‘fast mode’ by means of a step-up stage. Since for reasons of cost, fitting space and safety no clutch is fitted between the retarder and a shaft that is driving the retarder, the mechanical components basically continue rotating even when the retarder is not operating with a braking effect and they therefore give rise to corresponding losses. This results in increased fuel consumption of the vehicle. Part of the retarder's overall loss is produced by the step-up stage, which is usually in the form of a spur gear pair that converts the retarder rotational speed to the fast range relative to the transmission output rotational speed. The losses consist essentially of splash and friction losses of the gearwheels. However, for reasons of space, the retarder shaft is often lower down in the transmission housing than the transmission output shaft, so that the gearwheel of the step-up stage arranged on the retarder shaft is immersed a certain distance under the oil level which varies dynamically during the operation of the transmission. During braking operation this is desirable and necessary, because the teeth of the step-up stage are very effectively lubricated and cooled thereby. Further losses take place in the rotary bearings of the shaft driving the retarder. Here too, during braking operation sufficient lubrication and cooling is unconditionally necessary, but during traction operation of the vehicle the components can get by with substantially less oil.

In order to ensure the lubrication and cooling of the components of the retarder of a vehicle transmission in different operation conditions and thereby to reduce the aforesaid losses, in DE 10 2009 026 721 A1 a vehicle transmission with a hydrodynamic retarder is proposed, which has a device for driving and controlling the retarder, with bearings of the retarder and of the device for driving and controlling it and with means for lubricating and cooling the bearings and the device. In addition, means are provided for enabling differentiated lubrication and cooling of the bearings and the driving and control device with lubrication and cooling media during the braking operation of the retarder compared with when it is in a non-braking operating mode. These means for enabling differentiated lubrication and cooling are activated as a function of actuation signals of the retarder. For this a control valve is provided, which reacts to the actuation signal from an actuation sensor, for example on the brake pedal or on a brake lever, and which produces the retarder control pressure so that the lubricant and coolant is delivered as a function of the retarder control pressure. In the hydraulic retarder control system there is a control pressure whose value is zero during non-braking operation. During braking operation that control pressure is set by an electromagnetic valve in accordance with the braking torque required and the resulting pressure demand, to values between zero and the maximum control pressure. This results in a corresponding pump pressure. The control pressure and the braking torque are directly related. The higher the control pressure is, the larger the braking torque will be when the retarder is switched on. By relating the lubrication and cooling supply to the control pressure as a load-dependent quantity, a load-dependent lubricant and coolant volume flow is produced. The lubricant and coolant volume flow is produced by a pump, which is coupled to the rotor shaft of the retarder and which determines the lubricant and coolant volume flow via the control valve to the bearings that have to be lubricated and cooled.

This vehicle transmission disclosed in DE 10 2009 026 721 A1 takes into account the fact that during braking operation of the retarder, owing to operating forces higher power losses have to be dissipated in the bearings and teeth, and it satisfies the requirement for load-dependent cooling and lubrication during braking operation of the retarder by correspondingly reducing the power loss. During non-braking operation of the retarder, i.e. when the bearings are not under load, the necessary lubricant and coolant volume flow is indeed substantially smaller but it has to be matched to the maximum retarder rotational speed, even though at low rotational speeds far less cooling and lubrication would be required. Furthermore, for the control of the lubricant and coolant volume flow, a control valve is needed, which reacts to the actuation signals from the brake pedal or brake lever, which produces the retarder control pressure and which delivers the lubricant and coolant as a function of the retarder control pressure.

In DE 10 2009 026 721 A1 the lubricant and coolant are delivered with the help of a pump. As an example of such a pump, DE 10 2006 061 326 A1 describes a pump having a pressure chamber and a control ring mounted to pivot about a pivoting axis, which undergoes a pivoting motion and which during the pivoting motion can pivot through a deflection angle. Such pumps, also known as reciprocating vacuum pumps or rotary vane pumps, are used in automotive applications as well. For example, they are also proposed as pumps in a hydrodynamic retarder described in DE 10 2008 000 901 A1.

### SUMMARY OF THE INVENTION

Against that background the purpose of the present invention is to propose a pump which can be controlled more simply and, by virtue of such a pump, to improve the lubricant and coolant supply to a hydrodynamic retarder equipped therewith and to minimize power losses in a vehicle transmission with such a retarder,

These objectives are achieved by the characteristics specified in the description below. Advantageous further developments and design features of the invention are described below.

The invention starts from the realization that the control of a pump with a pivoting control ring, in particular a reciprocating vacuum pump or rotary vane pump, takes place internally by virtue of the pivoting control ring, which is pivoted in such manner that the pump is adjusted to zero-delivery so that no power loss is caused by diverting the pump delivery volume through a pressure regulating valve.

The pump according to the invention comprises a pressure chamber and a control ring mounted to pivot about a pivoting axis so that it undergoes pivoting motion, such that during its pivoting motion the control ring pivots through a specified deflection angle.

A deflection angle is understood to mean the angle through which the control ring sweeps during its pivoting motion. A minimal deflection angle is reached in a position of the control ring when the compression spring is at maximum extension. A maximum deflection angle corresponds to a position of the control ring in which the compression spring is compressed to its maximum extent,

This pivoting motion of the control ring can be used to adjust the medium delivered by the pump in accordance with requirements, in that the control ring is used to open an aperture in the pressure chamber of the pump to a greater or lesser extent, or to close it off completely, depending on the position and deflection angle of the control ring.

In an advantageous version of the invention, the deflection angle of the pivoting motion of the control ring depends on the rotational speed of the pump and is in a characteristic ratio to the pump rotational speed. What this achieves is that as a function of the rotational speed and the concomitant loading of components to be supplied with lubricant or coolant, by virtue of the corresponding pivoting of the control ring the aperture is opened sufficiently for an appropriately large lubricant and coolant volume flow to be delivered to the components to be supplied.

The control ring of the pump is acted upon by the spring force of a compression spring, and in an advantageous design the aperture in the pressure chamber when the deflection angle of the control ring about its pivoting axis is a minimum, is closed to its maximum extent (at low rotational speed). When the deflection angle of the control ring is at a maximum (at high rotational speed), the aperture in the pressure chamber is opened to the maximum extent against the spring force of the compression spring.

Advantageously, the control ring can be provided with a control edge which, depending on the pivoted position of the control ring, closes the aperture to a greater or lesser extent, the aperture preferably being formed in a side face of the pump housing or in a housing cover thereof.

For fine control of the lubricant and coolant volume flow the aperture can consist of a plurality of bores arranged in the movement direction of the pivoting motion of the control edge of the control ring, the bores having equal and/or different diameters, or else the aperture can also be in the form of an elongated slot that narrows in the closing direction, for example in a wedge shape.

Furthermore, it can be provided that the at least one aperture is arranged approximately diametrically opposite the pivoting axis in the pump housing.

The angular position of the aperture and the control edge of the control ring relative to the pivoting axis can be chosen such that there are specific opening and closing points in the swivel range of the control ring, by virtue of which a rotational speed limit for the opening and closing can be set,

The invention also concerns a hydrodynamic retarder and a pump associated with the retarder, which supplies a lubricating and cooling medium at least to bearings of rotating components of the retarder, such that means are provided which bring about differentiated lubrication and cooling at least of the bearings when the retarder is in braking operation and in non-braking operation.

According to the invention, for this it is provided that the pump is designed with a control ring mounted to be able to pivot about a pivoting axis, wherein the control ring communicates on one side with a pressure chamber and on the other side with a suction chamber, and wherein, in the pivoting movement range of the control ring, an aperture is located which is in communication by way of a lubricant and coolant line at least with the bearings in which the rotating components of the retarder are mounted.

As mentioned, the invention starts from the realization that the control of a reciprocating vacuum pump or rotary vane pump takes place internally by means of the control ring mounted to pivot, which is pivoted in such manner that the pump is adjusted to zero delivery so that no power loss occurs due to diversion of the pump delivery volume through a pressure regulating valve. This pivoting motion of the control ring can be used in order to adjust the lubricant and coolant volume flow supplied at least to the bearings of the retarder in accordance with the mechanical loading and rotational speed, in that the control ring is used to open or close to a greater or lesser extent an aperture to the delivery chamber of the pump which communicates by way of a lubricant and coolant line at least with the bearings of the retarder, depending on the position of the control ring.

Correspondingly, the aperture that communicates at least with the bearings of the retarder via the lubricant and coolant line is at least to a predominant extent or even completely closed when the control ring is at its maximum deflection, this being the case in particular at low rotational speeds and low loads when there is no great need for a large lubricant and coolant volume flow, but when the deflection of the control ring is at a minimum, i.e. as a rule at high rotational speeds and high loads, the aperture that communicates at least with the bearings of the retarder by way of the lubricant and coolant line is fully open and thus admits a large volume flow of lubricant and coolant to the bearings.

To set a through-flow characteristic for the lubricant and coolant volume flow to the bearings, an outflow diaphragm aperture can advantageously be arranged in the area between the aperture and the bearings.

Finally, the invention concerns a vehicle transmission with a hydrodynamic retarder and a pump associated with the retarder, which pump supplies a lubricant and coolant at least to bearings for rotating components of the retarder. The pump comprises a control ring mounted to pivot about a pivoting axis, which undergoes a pivoting motion. The control ring communicates on one side with a pressure chamber and on the other side with a suction chamber. By virtue of its pivoting movement the control ring opens or closes an aperture in the pressure chamber of the pump to varying extents, in order to provide differentiated lubrication and cooling of the bearings when the retarder is in braking operation and in non-braking operation.

### BRIEF DESCRIPTION OF THE DRAWINGS

Below, the invention will be explained further with reference to an example embodiment illustrated in the drawings, which show:

FIG. 1: A schematic view of part of a vehicle transmission having a hydrodynamic retarder with an associated pump for lubricant and coolant,

FIG. 2: A schematic sectioned view through a rotary vane pump according to the invention, in a first delivery setting,

FIG. 3: A schematic sectioned view through the rotary vane pump of FIG. 2, in a second delivery setting,

FIG. 4: A schematic view of a second embodiment, showing an aperture in the rotary vane pump of FIG. 1 connected by a lubricant and coolant line to the bearings, and

FIG. 5: A schematic view of a third embodiment, showing an aperture in the rotary vane pump of FIG. 1 that communicates by way of a lubricant and coolant line with the bearings.

### DETAILED DESCRIPTION OF THE PREFERRED EMBODIMENTS

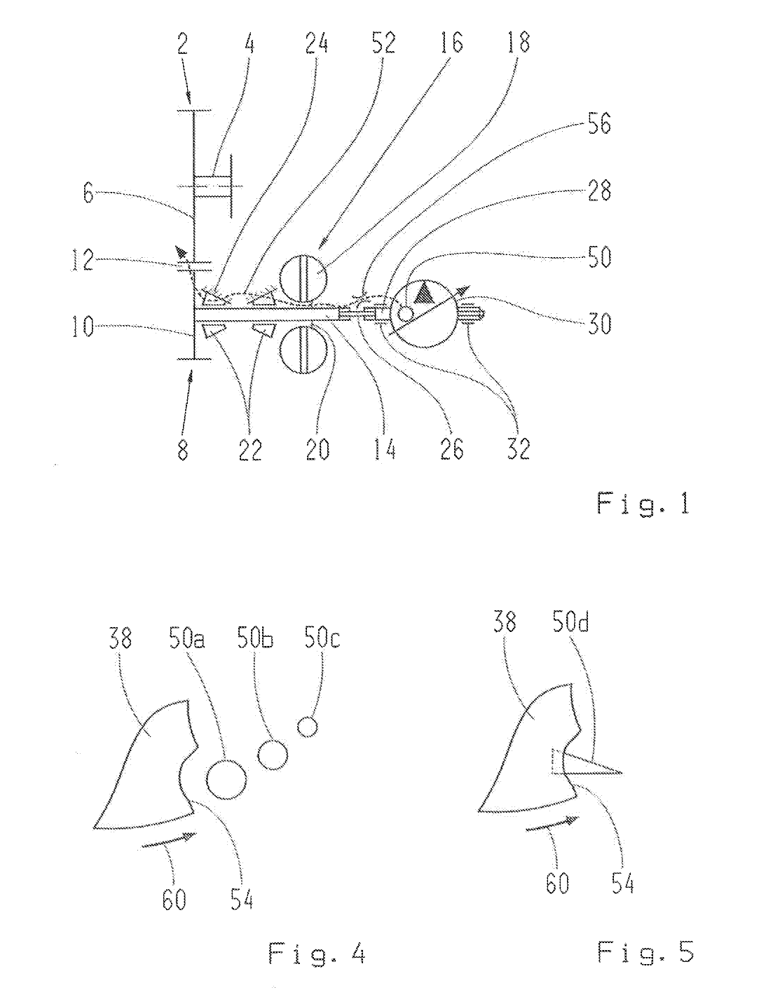

FIG. 1 shows schematically a transmission output shaft 4 of a vehicle transmission 2, on which a first gearwheel 6 of a step-up stage 8 is fixed. A second gearwheel 10 of the step-up stage 8 meshes with the first gearwheel 6 by way of teeth 12. The second gearwheel 10 is connected in a rotationally fixed manner to a rotor shaft 14 of a retarder 16, whose rotor 18 is coupled rotationally fixed to the rotor shaft 14 by means of driving teeth 20. The rotor shaft 14 is mounted by means of two bearings 22 to rotate in a housing 24. By way of a pump coupling 26, a pump shaft 28 of a pump 30 is connected to the rotor shaft 14. The pump shaft 28 is mounted by means of two bearings 32 to rotate in the housing 24.

The pump 30 is a controlled reciprocating vacuum pump or rotary vane pump whose basic structure is known from DE 10 2010 010 799 A1. The mode of operation of a reciprocating vacuum pump is described in detail in DE 195 32 703 C1, in particular as regards its control. The content of those two documents is here included completely in the object of the present disclosure.

FIG. 2 shows the reciprocating vacuum pump 30 according to FIG. 1, which comprises in a pump housing 34, a control ring 38 mounted to pivot about a pivoting axis 40. This control ring 38 is mounted and sealed in the pump housing 34 in such manner that it can be acted upon by the pressure in a pressure chamber 42 and can thereby be pivoted against the force of a spring 44 accommodated in a suction chamber 48. Inside the control ring 38, in a known manner a rotor 36 can be driven in rotation by means of the pump shaft 28. The pump shaft 28 is mounted to rotate in the pump housing 34 by means of the bearing 32 shown in FIG. 1.

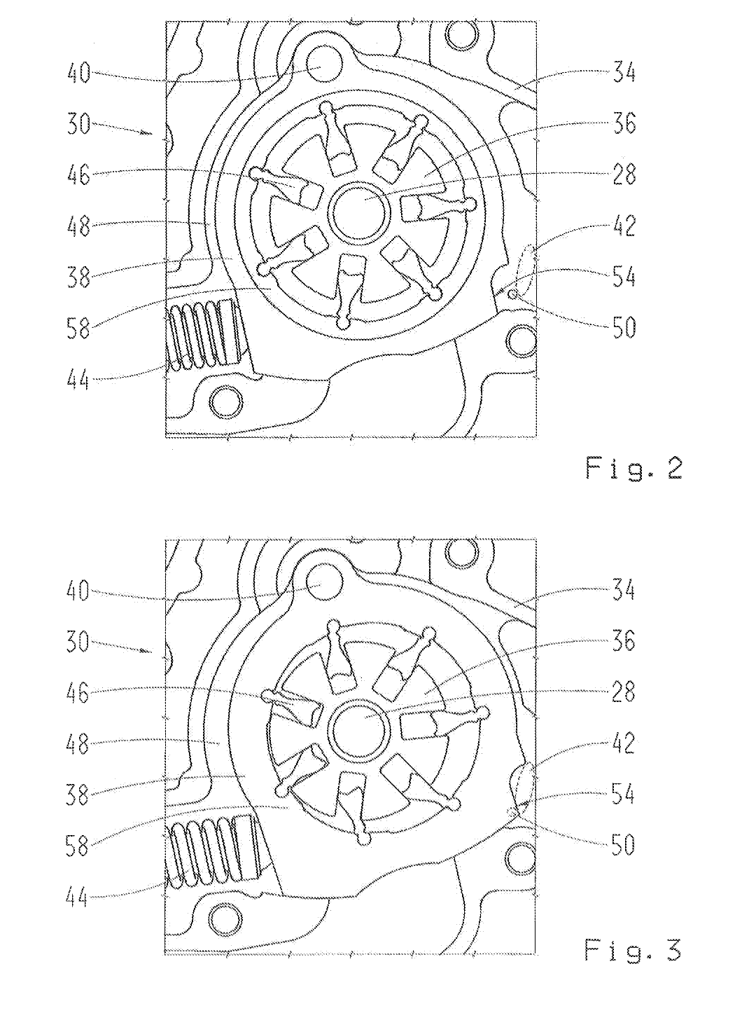

In the control ring 38 is mounted to rotate an outer rotor 58 which is connected in a rotationally fixed manner to the rotor 36 by means of pendulum drive elements 46 fitted into the outer rotor 58. When the control ring 38 pivots about its pivoting axis 40 the pump 30 can be adjusted between a position shown in FIG. 2 which gives a minimum delivery volume flow and a position shown in FIG. 3 which given a maximum delivery volume flow, This takes place automatically since when the pump 30 is operating a pressure builds up in the pressure chamber 42, which is as a rule the pump pressure. If the pressure increases toward the nominal pump pressure, the pressure in the pressure chamber 42 causes the control ring 38 to pivot in opposition to the force of the spring 44.

In the actuation position shown in FIG. 2 the control ring 38 and the outer rotor 58 arranged therein have only a slight eccentricity relative to the rotor 36, whereby the pump 30 is set to its minimum delivery capacity. In this position a control edge 54 radially on the outside of the control ring 38 allows passage through an aperture 50 in the pump housing 34, which aperture communicates by way of a lubricant and coolant line (FIG. 1) at least with the bearings 22 of the rotor shaft 14 of the retarder 16. Preferably, the bearings 32 of the pump shaft 28 and the teeth 12 of the step-up stage 8 are also supplied with lubricant and coolant by way of the lubricant and coolant line 52. In the actuation position of the pump 30 shown in FIG. 2, the largest possible lubricant and coolant volume flow is supplied to the bearings 22 and 32 and to the step-up stage 8. As a rule this position corresponds to non-braking operation of the retarder 16 at high rotational speeds of the transmission output shaft 4, during which an abundant supply of lubricant and coolant to the step-up stage 8 and to the bearings 22 and 32 is required.

FIG. 3 shows a position of the control ring 38 in which the pump 30 is set to its maximum delivery position. In this position the aperture 50 in the pump housing 34 is at least mostly or even completely closed, so that only a very small volume flow of lubricant and coolant passes to the step-up stage 8 and to the bearings 22 and 32. As a rule this operating position of the pump 30 corresponds to a low rotational speed of the transmission output shaft 4 and to non-braking operation of the retarder 16, when the size of the lubricant and coolant volume flow required is small. Intermediate positions of the control ring 38 result in partial opening of the aperture 50 in the pump housing 34 by the control edge 54 of the control ring 38, with corresponding adjustment of the size of the lubricant and coolant volume flow,

As can be seen in FIG. 4, the aperture 50 in the pump housing 34 can be subdivided into a plurality of bores 50a, 50b, 50c a distance apart in the pivoting direction 60 of the control ring 38, the bores having different diameters, whereby depending on the pivoted position of the control ring 38, the lubricant and coolant volume flow can be controlled stepwise by the control edge 54.

Continuous control of the lubricant and coolant volume flow is enabled by an aperture 50d as shown in FIG. 5, in that the aperture 50d is for example in the form of a wedge-shaped slot with a tapering cross-section.

The angular position of the aperture 50, the bores 50a, 50b, 50c or of the slot 50d and the control edge 54 of the control ring 38 relative to the pivoting axis 40 can be chosen such that there are predetermined opening and closing points which can differ from the maximum positions shown in FIGS. 2 and 3, by which means lower and upper rotational speed limits can be set.

In the lubricant and coolant line 52 at least one outflow diaphragm aperture 56 can be arranged, which enables the setting of a through-flow characteristic to the bearings 22 and/or 32 and to the teeth 12 (FIG. 1). As shown in FIGS. 2 and 3 the aperture 50, the bores 50a, 50b, 50c or the slot 50d can be located in a side face of the pump housing 34 or in a housing cover of the pump 30. Likewise, as shown it is possible to position the aperture 50, the bores 50a, 50b, 50c or the slot 50d in a sealing surface of the pump housing 34 approximately diametrically opposite the pivoting axis 40.

By virtue of the action of pressure on the control ring 38 on the pressure chamber side 42 in opposition to the force of the spring 44, a constant pump pressure is produced. By virtue of the adjustment movement of the control ring 38, the pump pressure can be kept constant over the entire rotational speed range. The adjustment path or deflection angle of the control ring 38 is accordingly in a characteristic ratio to the rotational speed, so that as the rotational speed increases the deflection angle of the control ring 38 becomes larger and the lubricant and coolant flow volume therefore also becomes larger. Thus, the control ring 38 can be regarded as a gate that operates in a rotational speed dependent manner. By way of the aperture 50, the bores 50a, 50b, 50c or the slot 50d, over the adjustment range of the control ring 38 lubricant and coolant can be drawn off and supplied to the bearings 22 and 32 and to the teeth 12. In this case, at low rotational speeds the aperture 50, the bores 50a, 50b, 50c or the slot 50d are mostly or fully closed. At the maximum rotational speed the outflow cross-section is largest and the volume flow of lubricant and coolant is as large as possible.

LIST OF INDEXES

1 Vehicle transmission

4 Transmission output shaft

6 First gearwheel

8 Step-up stage

10 Second gearwheel

12 Teeth

14 Rotor shaft

16 Retarder

18 Rotor

20 Driving teeth

22 Rotor shaft bearing

24 Housing

26 Pump clutch

28 Pump shaft

30 Pump

32 Pump shaft bearing

34 Pump housing

36 Rotor

38 Control ring

40 Pivoting axis

42 Pressure chamber

44 Spring

46 Pendulum drive element

48 Suction chamber

50 Aperture

50a Bore

50b Bore

50c Bore

50d Slot

52 Lubricant and coolant line

54 Control edge

56 Outflow diaphragm aperture

58 Outer rotor

60 Pivoting direction of the control ring

1-12. (canceled)

13. A pump (30) comprising:
a pressure chamber (42) and a control ring (38) which is mounted to pivot about a pivoting axis (40) and undergoes a pivoting motion, and the control ring during pivoting motion being pivotable through a deflection angle,
an aperture (50, 50a, 50b, 50c, 50d) being provided in the pressure chamber (42) of the pump (30) and, due to the pivoting motion of the control ring, the aperture (50, 50a, 50b, 50c, 50d) either opening or closing to various extents.

14. The pump (30) according to claim 13, wherein the deflection angle of the pivoting motion of the control ring (38) is a function of a rotational speed of the pump (30).

15. The pump (30) according to claim 13, wherein the control ring (38) is acted upon by a spring force of a compression spring (44) and when the deflection angle of the control ring (38) about the pivoting axis (40) is at a minimum, the aperture (50, 50a, 50b, 50c, 50d) is either at least mostly or completely closed, and
when the deflection angle of the control ring (38) against the spring force of the compression spring is at a maximum, the aperture is open to a maximum extent.

16. The pump (30) according to claim 13, wherein the control ring (38) comprises a control edge (54) which closes the aperture (50, 50a, 50b, 50c, 50d), to either a greater or a lesser extent, as a function of the pivoted position of the control ring (38).

17. The pump according to claim 13, wherein the aperture (50, 50a, 50b, 50c, 50d) is located either on a side face of a pump housing (34) or in a housing cover of the pump (30).

18. The pump (30) according to claim 13, wherein the aperture comprises of a plurality of bores (50a, 50b, 50c) arranged in a direction of movement of the pivoting motion of the control ring (38), and the plurality of bores having either equal or different diameters.

19. The pump (30) according to claim 13, wherein the aperture is an elongated slot (50d) which narrows in a closing direction.

20. The pump (30) according to claim 17, wherein the aperture (50, 50a, 50b, 50c, 50d) is arranged in the pump housing (34) approximately diametrically opposite the pivoting axis (40).

21. The pump (30) according to claim 13, wherein an angular position of the aperture (50, 50a, 50b, 50c, 50d) and of the control ring (38), relative to the pivoting axis (40), are selected in such manner that predetermined opening and closing points, over a range of pivoting motion of the control ring (38), are defined.

22. A hydrodynamic retarder (16) with a pump (30) connected to the retarder (16), which supplies at least bearings (22) for rotating components of the retarder (16) with a lubricating and cooling medium, the pump having an aperture (50, 50a. 50b, 50c, 50d) which bring about differentiated lubrication and cooling at least of the bearings (22) during braking operation and during non-braking operation of the retarder (16), the pump (30) having a pressure chamber (42) and a control ring (38), the control ring being mounted to undergo pivoting motion about a pivoting axis (40), by virtue of the pivoting motion the control ring (38) either opens or closes the aperture (50. 50a, 50b, 50c, 50d) in the pressure chamber (42) of the pump (30) to different extents, the aperture communicating with at least the bearings (22) for rotating components of the retarder (16) by way of a lubricant and coolant line (52), in order to bring about the differentiated lubrication and cooling of at least of the bearings (22) during braking and during non-braking operation of the retarder (16).

23. The hydrodynamic retarder (16) according to claim 22, wherein an outflow diaphragm aperture (56) for setting a through-flow characteristic is arranged in a flow path of the lubricant and coolant between the aperture (50, 50a, 50b, 50c, 50d) and at least one of the bearings (22) for a rotor shaft (14) and the bearings (32) for a retarder shaft (28).

24. A vehicle transmission (2) with a hydrodynamic retarder (16), a pump (30) being connected to the retarder (16) for supplying lubricant and coolant at least to bearings (22) of rotating components of the retarder (16),
the pump comprising a pressure chamber (42) and a control ring (38) which is mounted to pivot about a pivoting axis (40) and which undergoes a pivoting motion,
the control ring, by virtue of pivoting motion thereof, either opens or closes an aperture (50, 50a, 50b, 50c, 50d) in the pressure chamber (42) of the pump (30) to varying extents in order to bring about differentiated lubrication and cooling, at least of the bearings (22), during braking and during non-braking operation of the retarder (16).

25. The pump (30) according to claim 13, in combination with a hydrodynamic retarder (16), the pump is connected to the retarder and supplies at least bearings (22) of rotating components of the retarder (16) with a lubricating and cooling medium,
the pump has an aperture (50, 50a, 50b, 50c, 50d) which facilitates different flow volumes of the lubrication and cooling medium to at least the bearings (22) during braking operation and during non-braking operation of the retarder (16),
the pump (30) has a pressure chamber (42) and a control ring (38), and the pivoting motion of the control ring (38) either opens or closes the aperture (50, 50a, 50b, 50c, 50d) in the pressure chamber (42) of the pump (30) to various degrees, and
a lubricant and coolant line (52) communicates with the aperture for conveying the lubricant and coolant medium from the pressure chamber to at least the bearings (22) of the rotating components of the retarder (16).

26. The pump (30) according to claim 13, in combination with a vehicle transmission (2) which has a hydrodynamic retarder (16), the pump (30) is connected to the retarder (16) and supplies lubricant and coolant at least to bearings (22) of rotating components of the retarder (16),
the control ring opens and closes the aperture to different degrees based on the pivoting motion thereof, in order to bring about differentiated lubrication and cooling of at least the bearings (22) during braking and during non-braking operation of the retarder (16).
